(19) United States
(12) Patent Application Publication
(10) Pub. No.: US 2003/0123830 A1
(43) Pub. Date: Jul. 3, 2003

(54) Optical amplifier with gain flattening filter

(76) Inventor: Aydin Yeniay, Strafford, PA (US)

Correspondence Address: MONTE & MCGRAW, PC, 4092 SKIPPACK PIKE, P.O. BOX 650, SKIPPACK, PA, 19474, US

(21) Appl. No.: 10/299,471

(22) Filed: Nov. 18, 2002

Related U.S. Application Data
(60) Provisional application No. 60/331,840, filed on Nov. 19, 2001.

(51) Int. Cl. G02B 6/10

(52) U.S. Cl. 385/131; 385/129

(57) ABSTRACT

A waveguide optical amplifier is disclosed. The optical amplifier includes a substrate and a cladding layer disposed on the substrate. The waveguide optical amplifier also includes an amplifying core disposed within the cladding layer and a secondary core disposed within the cladding layer proximate the amplifying core. The secondary core is adapted to absorb at least a portion of a light signal being transmitted through the amplifying core. A feedback loop for dynamically changing the amount of light being absorbed and a method for dynamically controlling light signal absorption are also provided.

### FIELD OF THE INVENTION

The present invention relates to optical amplifiers with incorporated gain flattening filters.

### BACKGROUND OF THE INVENTION

Optical communication systems based on optical fibers allow communication signals to be transmitted not only over long distances with low attenuation, but also at extremely high data rates, or bandwidth capacity. This capability arises from the propagation of a single mode optical signal in the low-loss windows located at the near-infrared wavelength of 1550 nm. Since the introduction of erbium-doped fiber amplifiers (EDFAs), the last decade has witnessed the emergence of single-mode optical fibers as the standard data transmission medium for wide area networks (WANs), especially in terrestrial and transoceanic communication backbones. In addition, the bandwidth performance of single-mode optical fiber has been vastly enhanced by the development of dense wavelength division multiplexing (DWDM), which can couple up to 40 channels of different wavelengths of light into a single fiber, with each channel carrying up to 10 gigabits of data per second. Moreover, recently, a signal transmission of 10 terabit (10¹³ bits) per second has been achieved over a single 100 kilometer fiber on a 120-channel DWDM system. Bandwidth capacities are increasing at rates of as much as an order of magnitude per year.

The success of the single-mode optical fiber in long-haul communication backbones has given rise to the new technology of optical networking. The universal objective is to integrate voice video, and data streams over all-optical systems as communication signals make their way from WANs down to smaller local area networks (LANs) of Metro and Access networks, fiber to the curb (FTTC), fiber to the home (FTTH), and finally arriving to the end user by fiber to the desktop (FTTD). Examples are the recent explosion of the Internet and use of the World Wide Web, which are demanding vastly higher bandwidth performance in short- and medium-distance applications. Yet, as the optical network nears the end user starting at the LAN stage, the network is characterized by numerous splittings of the input signal into many channels. This feature represents a fundamental problem for optical networks. Each time the input signal is split, the signal strength per channel is naturally reduced.

EDFA's are used to amplify signal lights in optical telecommunications systems. In the C band range (between approximately 1525 nm and 1565 nm), EDFA's provide non-uniform amplification over the bandwidth. A diagram of a typical spectral shape of a C band EDFA is shown in FIG. 1. This non-uniform amplification becomes problematic for wavelength division multiplexing systems since some wavelengths, especially those around 1535 nm, experience significantly more gain than other wavelengths, resulting in accumulation of gain non-uniformity in the system. Long period fiber Bragg gratings are already known for gain flattening. However, these gratings must be inserted between amplifier stages, limiting integration capacity of the system.

One current solution is to provide a twin core erbium doped fiber, in which two cores extend through a fiber cladding, separated by a generally constant distance. The first core, doped with erbium, amplifies a signal light through the fiber. The proximity of the first core to the second core provides a coupling effect, in which, at predetermined wavelengths, some of the signal light from the first core transfers to the second core, flattening some of the gain realized while transmitting the signal light through the first, or erbium doped, core. A drawback to this approach is that, due to manufacturing constraints, both cores extend the entire length of the fiber, reducing the ability to regulate the amount of the signal light transferred between cores. An additional drawback to a twin core erbium doped fiber is that, since the spacing between each core is generally constant, the coupling efficiency of the fiber is not adjustable, and only wavelengths within a predetermined bandwidth can be flattened.

Another solution is to provide a wavelength division multiplexer (WDM) in a planar waveguide in which a signal line is optically coupled with a signal flattening line. A portion of the light in the signal line transfers to the signal flattening line, thereby attenuating the signal in the signal line. The amount of attenuation can be predetermined by the length of the coupling between the signal line and the signal flattening line. However, the signal attenuation is fixed, and cannot be readily adjusted.

It would be beneficial to provide a gain flattening filter in an optical amplifier which can be adjusted to flatten an adjustably desired bandwidth by an adjustably desired amount, thus manipulating the gain shape of the amplifier.

### BRIEF SUMMARY OF THE INVENTION

Briefly, the present invention provides a waveguide optical amplifier comprising a substrate and a cladding layer disposed on the substrate. The waveguide optical amplifier also comprises an amplifying core disposed within the cladding layer and a secondary core disposed within the cladding layer proximate the amplifying core. The secondary core is adapted to absorb at least a portion of a light signal being transmitted through the amplifying core.

Additionally, the present invention provides a dynamic gain flattening waveguide optical amplifier comprising a substrate and a cladding layer disposed on the substrate. The waveguide optical amplifier also comprises an amplifying core disposed within the cladding layer, the amplifying core having an output and a secondary core disposed within the cladding layer proximate the amplifying core. The waveguide optical amplifier further comprises a feedback loop including a tap optically connected to the output, a gain flattening controller optically connected to the tap, the gain flattening controller including a voltage generator, and an electrical conductor electrically connecting the voltage generator to a heater, the heater being disposed proximate to the secondary core.

Further, the present invention provides a method of dynamically flattening gain in a waveguide optical amplifier. The method comprises providing a dynamic gain flattening waveguide optical amplifier. The waveguide optical amplifier includes a substrate, a cladding layer disposed on the substrate, an amplifying core disposed within the cladding layer, the amplifying core having an output. The waveguide optical amplifier also includes a secondary core disposed within the cladding layer proximate the amplifying core and a feedback loop. The feedback loop includes a tap optically connected to the output, a gain flattening controller optically connected to the tap, the gain flattening controller including a voltage generator, and an electrical conductor electrically connecting the voltage generator to a heater, the heater being disposed proximate to the secondary core. The method further comprises transmitting an optical signal through the amplifying core, the amplifying core amplifying the optical signal and the secondary core attenuating the amplification of the optical signal over a selected bandwidth; tapping a portion of the amplified optical signal, generating a tapped signal; transmitting the tapped signal to a gain flattening controller; generating a voltage in the amplifier controller based on the value of the tapped signal; and transmitting the voltage to the heater, wherein the voltage changes the temperature of the heater, wherein the change in temperature changes the refractive index of the secondary core, and wherein the change in the refractive index changes the gain flattening of the amplified optical signal.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a graph showing typical amplification gain in a C band amplifier.

FIG. 2 is a perspective view of a planar waveguide optical amplifier with a gain flattening filter according to a first preferred embodiment of the present invention.

FIG. 3 is a sectional view of the planar waveguide optical amplifier, taken along section lines 3-3 of FIG. 2.

FIG. 4 is a schematic drawing of an amplifier module incorporating the planar waveguide optical amplifier according to the first preferred embodiment of the present invention.

FIG. 5 is a graph showing approximate gain flattened amplification in the C band range.

FIG. 6 is a perspective view of a planar waveguide optical amplifier with a dynamic gain flattening filter according to a second preferred embodiment of the present invention.

FIG. 7 is a sectional view of the planar waveguide optical amplifier, taken along section lines 7-7 of FIG. 6.

FIG. 8 is a schematic drawing of an amplifier module incorporating the planar waveguide optical amplifier according to the second preferred embodiment of the present invention.

FIGS. 9A-9K are planar views of alternative versions of the planar waveguide amplifier according to either of the first or second preferred embodiments of the present invention.

FIGS. 10A-10C are specific examples of alternative versions shown in FIGS. 9H, 9A, and 9F, respectively.

FIG. 11 is a graph showing calculated loss for wavelengths between 1520 and 1600 nm for the specific examples shown in FIGS. 10A-10C.

### DETAILED DESCRIPTION OF THE INVENTION

The present invention takes advantage of wavelength dependence on coupling efficiency between closely spaced cores in a waveguide optical amplifier to flatten the gain of optical signals as the optical signals are amplified by the waveguide optical amplifier. In the drawings, like numerals indicate like elements throughout.

A first embodiment of the present invention includes a planar optical waveguide amplifier 100, as shown in FIGS. 2 and 3. The amplifier 100 has an input end 102 and an output end 104. The amplifier 100 includes a substrate 110 and a lower cladding 120 disposed on the substrate 110. Preferably, the substrate 110 is constricted from a polymer, although those skilled in the art will recognize that the substrate 110 may be constructed from other materials, such as glass.

A plurality of cores 130, 132, 134 are disposed on the lower cladding 120 in generally straight, parallel lines. The core 130 is an amplifying core which extends from the input end 102 to the output end 104 and transmits a signal light λ_{S} through the amplifier 100. The cores 132, 134 are secondary, or gain flattening cores, which are proximate the amplifying core 130 and are separated from the amplifying core 130 by distances d₁ and d₂, respectively. Those skilled in the art will recognize that d₁ and d₂ can be the same or different distances and that the cores 132, 134 can be coplanar with the amplifying core 130, or non-coplanar. Preferably, the distances d₁ and d₂ are between 1.5 and 7.5 microns, although those skilled in the art will recognize that the distances d₁ and d₂ can be less than 1.5 microns and/or greater than 7.5 microns. Those skilled in the art will also recognize that one of the cores 132, 134 can be omitted, or that additional cores, not shown, can be disposed about the amplifying core 130. These additional cores can be coplanar with the cores 130, 132, 134 or non-coplanar.

Additionally, although FIG. 2 shows the cores 132, 134 having approximately the same length, those skilled in the art will recognize that the cores 132, 134 can have different lengths than each other and the amplifying core 130. Additionally, although FIG. 3 shows the cores 132, 134 to have approximately the same cross-sectional sizes, those skilled in the art will recognize that the cores 132, 134 can have different cross-sectional sizes. The alternatives for the cores 132, 134 as described above can be selected depending on the desired flattening characteristics of the amplifier 100.

The core 130 and the cores 132, 134 are preferably constructed from a polymer, such as a halogenated polymer, and preferably the same polymer, doped with a rare earth element. A preferred polymer is disclosed in U.S. Pat. No. 6,292,292 and U.S. patent application Ser. Nos. 09/722,821, filed Nov. 28, 2000 and 09/722,282, filed Nov. 28, 2000, which are all owned by the assignee of the present invention and are incorporated herein by reference in their entireties.

Those skilled in the art will recognize that the cores 130, 132, 134 can be applied to the lower cladding 120 by processes known to those skilled in the art, such as by spincoating, and then formed by other known process, such as reactive ion etching with photomasks.

An upper cladding 140 is disposed over the cores 130, 132, 134 and the portion of the lower cladding 120 not covered by the cores 130, 132, 134. Preferably, ends of the amplifying core 130 at the input 102 and the output 104 are not covered by the upper cladding 140 while the cores 132, 134 are preferably shorter than the amplifying core 130 and are completely covered by the upper cladding 140. Preferably, both the lower cladding 120 and the upper cladding 140 are constructed from a polymer, and more preferably, from the same polymer. Also preferably, the refractive indices of the lower and upper claddings 120, 140 are sufficiently close to the refractive index of the core 130 to allow for single mode optical signal propagation, as is well known by those skilled in the art.

In an optical amplifier module using the amplifier 100, as shown schematically in FIG. 4, a pump laser 150 is optically connected along a signal line 101 to the input 102 of the amplifier 100 through a coupler, preferably a wavelength division multiplexer (WDM) 152. The pump laser 150 provides a pump light λ_{P} to amplify a signal light λ_{S} which is transmitted along the signal line 101. Preferably, the signal light λ_{S} is within a bandwidth of approximately between 1525 nm and 1565 nm, although those skilled in the art will recognize that the bandwidth can be larger or smaller, and can be in a different range, such as a range encompassing less than 1525 nm or greater than 1565 nm.

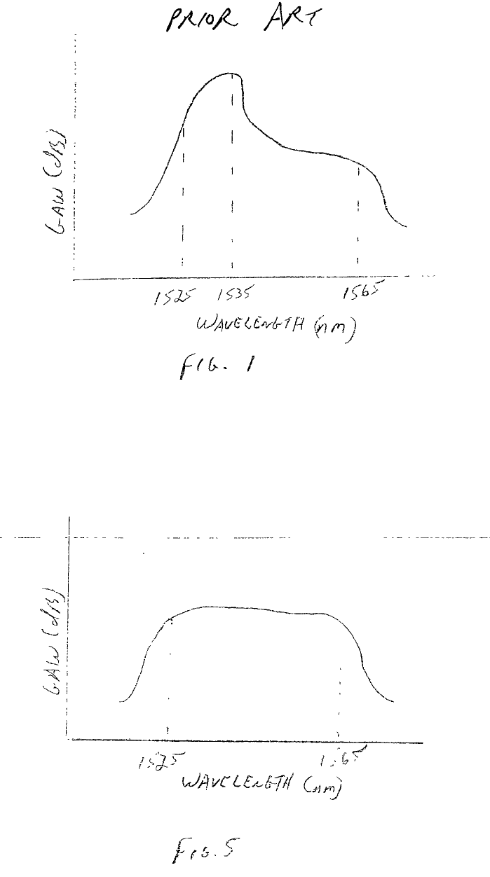

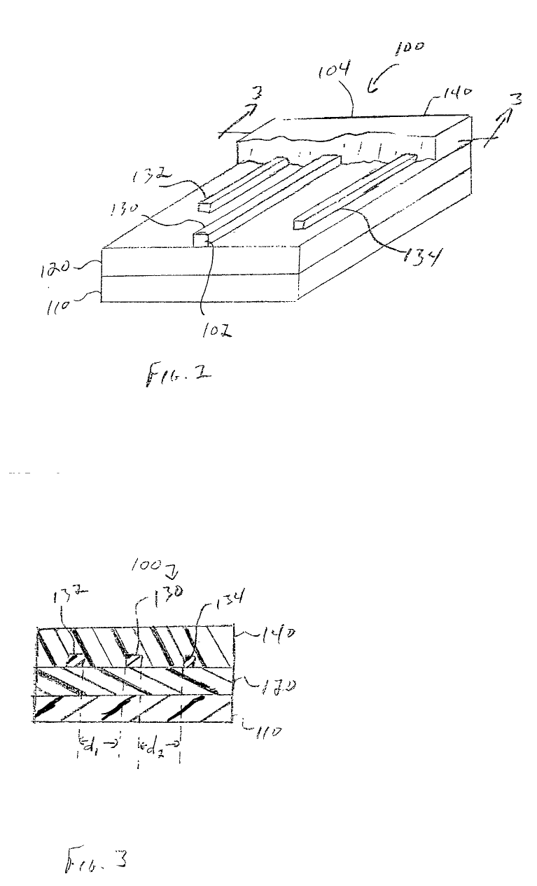

In operation, the signal light λ_{S} is transmitted along the signal line 101 toward the amplifier 100. The pump laser 150 generates the pump light λ_{P}, which combines with the signal light λ_{S} at the WDM 152. The combined signals λ_{S}, λ_{P} enter the amplifier 100 at the input 102 and travel through the amplifying core 130. In the amplifying core 130, the pump light λ_{P} excites the rare earth elements in the amplifying core 130, which in turn amplify the signal light λ_{S}. However, as is well known in the art, different wavelengths of the signal light λ_{S} are amplified different amounts, as was previously described in reference to FIG. 1. The gain flattening cores 132, 134 are shaped and disposed relative to the amplifying core 130 to couple predetermined wavelengths of the signal light λ_{S} from the amplifying core 130 into the gain flattening cores 132, 134, thus absorbing some of the signal light λ_{S}. The effect of such coupling is to reduce the amplification of the predetermined wavelengths to provide an amplification spectrum as shown approximately in FIG. 5.

A second embodiment of the present invention is a planar waveguide amplifier 200 as shown in FIGS. 6 and 7. The amplifier 200 incorporates a dynamic gain flattening feature to dynamically adjust gain flattening of the amplifier 200 based on output of the amplifier 200.

The amplifier 200 includes an input end 202 and an output end 204. The amplifier 200 includes a substrate 210 and a lower cladding 220 disposed on the substrate 210. A plurality of cores 230, 232, 234 are disposed on the lower cladding 220 in generally straight, parallel lines. The core 230 is an amplifying core which extends from the input end 202 to the output end 204 and transmits a signal light λ_{S} through the amplifier 200. The cores 232, 234 are secondary, or gain flattening cores, which are separated from the amplifying core 230 by distances d₃ and d₄, respectively.

An upper cladding 240 is disposed over the cores 230, 232, 234 and the portion of the lower cladding 220 not covered by the cores 230, 232, 234. Preferably, ends of the amplifying core 230 at the input 202 and the output 204 are not covered by the upper cladding 240 while the cores 232, 234 are preferably shorter than the amplifying core 230 and are completely covered by the upper cladding 240. Preferably, both the lower cladding 220 and the upper cladding 240 are constructed from a polymer, and more preferably, from the same polymer. Also preferably, the refractive indices of the lower and upper claddings 220, 240 are sufficiently close to the refractive index of the core 230 to allow for single mode optical signal propagation, as is well known by those skilled in the art.

A tap 254 is optically connected to the output 204 of the amplifier 200. The tap 254 is optically connected to feedback loop comprised of a gain flattening controller 260. The gain flattening controller 260 includes a voltage generator 262 that is opto-electronically connected to the tap 254. Heaters 270, 272 are electrically connected via electrical conductors 274, 276 to the voltage generator 262 and are each disposed in the amplifier 200 proximate to a secondary core 232, 234.

In an optical amplifier module using the amplifier 200, as shown schematically in FIG. 8, a pump laser 250 is optically connected along a signal line 201 to the input 202 of the amplifier 200 through a coupler, preferably a wavelength division multiplexer (WDM) 252. The pump laser 250 provides a pump light λ_{P} to amplify a signal light λ_{S} which is transmitted along the signal line 201. Preferably, the signal light λ_{S} is within a bandwidth of approximately between 1525 nm and 1565 nm, although those skilled in the art will recognize that the bandwidth can be larger or smaller, and can be in a different range, such as a range encompassing less than 1525 nm or greater than 1565 nm.

In operation, the signal light λ_{S}, generally having a bandwidth between approximately 1525 nm to 1565 nm, is transmitted to the input 202 of the amplifier 200. The signal light λ_{S} travels from the input 202 through the amplifying core 230, where the signal light λ_{S} is amplified by the pump light λ_{P} transmitted by the pump laser 250 as described above with reference to the first embodiment. A portion of the amplified signal light λ_{S} is directed into the secondary cores 232, 234, attenuating predetermined wavelengths of the signal light λ_{S}. As the amplified signal light λ_{S} exits the output 204 of the amplifier 200, a portion of the amplified signal light λ_{S}, preferably approximately 1% of the amplified signal light λ_{S}, is tapped by the tap 254 to form a tapped signal λ_{T}, which is sent to the gain flattening controller 260.

Preferably, the gain flattening controller 260 has been preprogrammed to compare the tapped signal λ_{T} to a predetermined value. If the tapped signal λ_{T} coincides with the predetermined value, the gain flattening controller 260 does not adjust the gain flattening of the amplifier 200. However, if the tapped signal λ_{T} does not coincide with the predetermined value, the gain flattening controller 260, through the voltage generator 262, generates and transmits a voltage based on the value of the tapped signal λ_{T} to the heaters 270, 272. The heaters 270, 272 change the temperature of the waveguide 200 proximate the secondary cores 232, 234, which changes the refractive index of the secondary cores 232, 234. This change in the refractive index of the secondary cores 232, 234 alters the coupling properties of the secondary cores 232, 234, which in turn alters the gain flattening characteristics of the cores 232, 234. By altering the gain flattening characteristics of the cores 232, 234, the gain shape of the amplifier 200 is changed and predetermined wavelengths of the signal light λ_{S} can be attenuated. The gain shape of the amplifier 200 can be changed to match the predetermined value in the gain flattening controller 260.

The present invention takes advantage of wavelength dependence of coupling efficiency between closely spaced multiple cores; dynamical change of the core properties as a function of temperature, which gives rise to proportional changes in coupling properties; and fabrication flexibility of such structures in a waveguide form. The coupling efficiency of the cores 132, 134, 232, 234 is affected by multiple factors, including the refractive indices of the cores 132, 134, 232, 234 and the claddings 120, 140, 220, 240; the change in refractive index as a function of temperature (dn/dT); the shape of the cores 130, 132, 134, 230, 232, 234, the distances d₁, d₂, d₃, d₄ between the cores 130, 132, 134 and 230, 232, 234; the diameters of the cores 130, 132, 134, 230, 232, 234; and the materials comprising the cores 132, 134, 232, 234 and the claddings 120, 140, 220, 240.

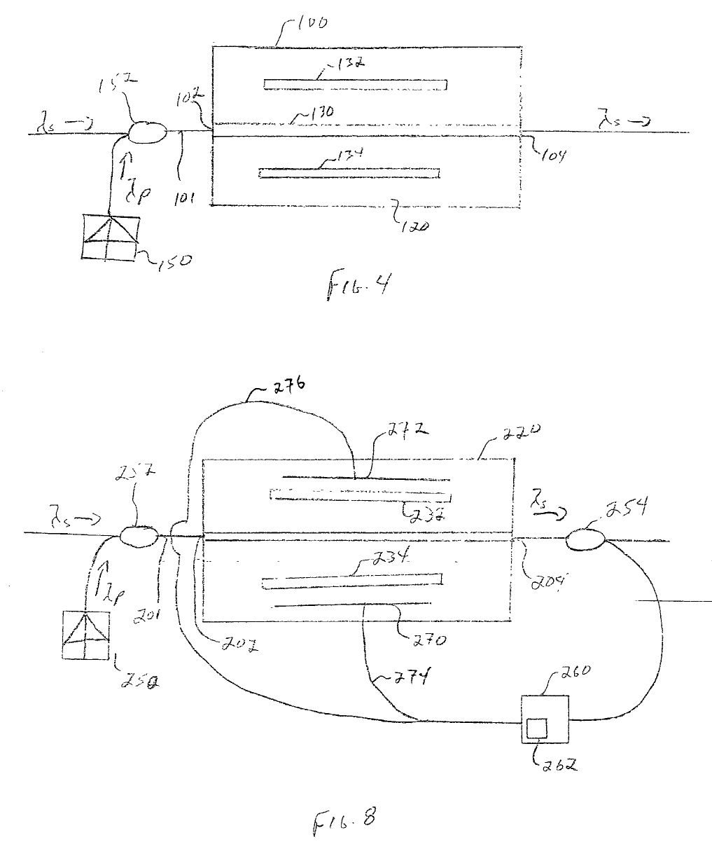

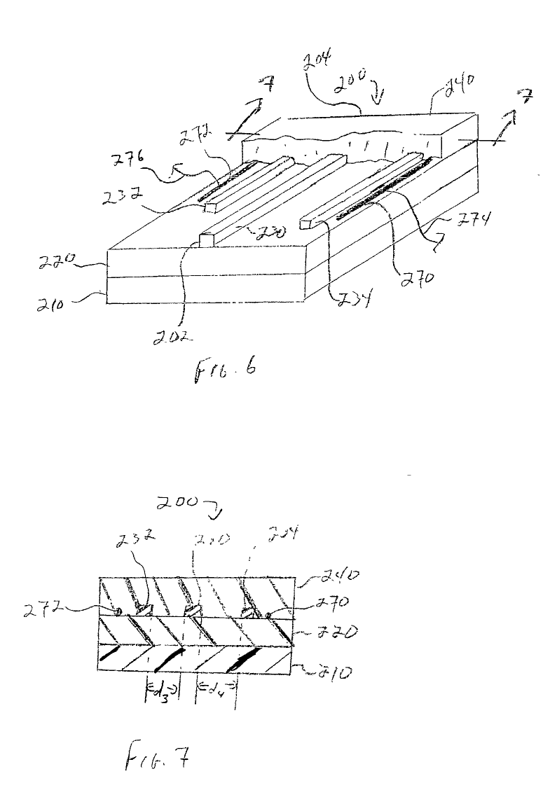

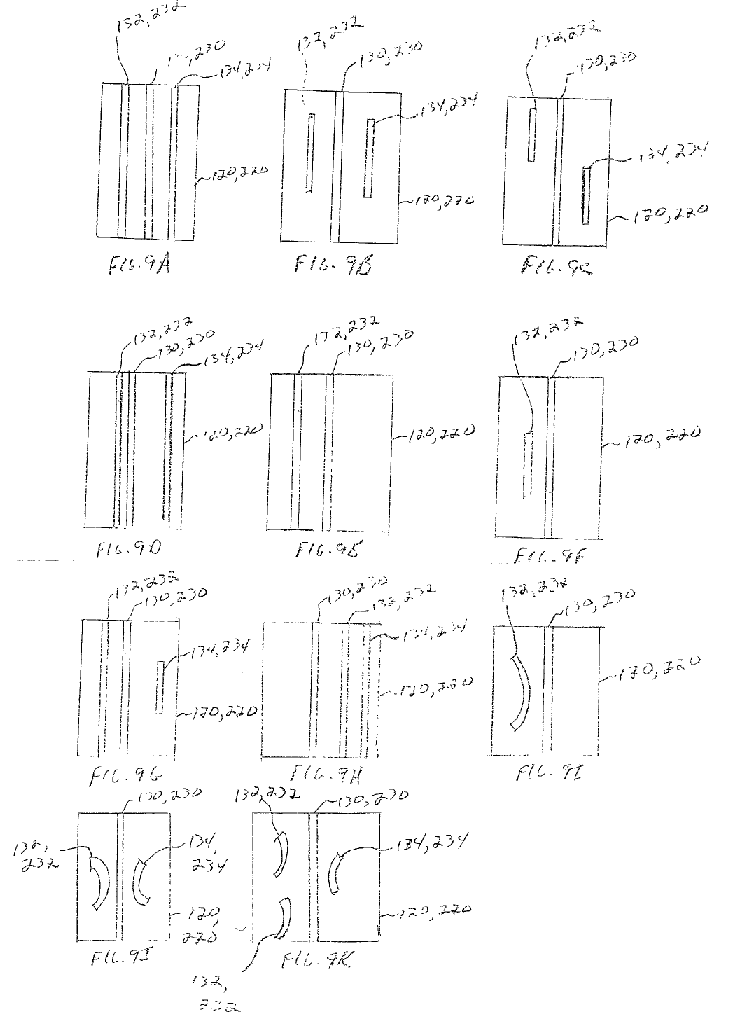

Possible configurations of the cores 130, 132, 134, 230, 232, 234 of the first and second embodiments of the amplifiers 100, 200 are shown in FIGS. 9A through 9K. Although eleven configurations are shown in FIGS. 9A through 9K, the configurations shown are representative of optional designs and are not meant to be limiting in any way. For example, those skilled in the art will recognize that the configurations in FIGS. 9F and 9I can be combined to provide a waveguide with a straight gain flattening core on one side of the amplifying core, and a curved gain flattening core juxtaposed from the straight gain flattening core across the amplifying core.

While the cores 130, 132, 134, 230, 232, 234 disclosed in FIGS. 9A through 9K are generally straight line channels, those skilled in the art will recognize that other shapes can be used, such as the curved waveguide shape disclosed in U.S. patent application Ser. No. 09/877,871, filed Jun. 8, 2001, which is owned by the assignee of the present invention and is incorporated herein by reference in its entirety.

FIGS. 10A through 10C show dimensions of specific examples of the general configurations shown in FIGS. 9H, 9A, and 9F, respectively, with calculated loss measurements using BPV software shown in the graph of FIG. 11. Those skilled in the art will recognize that different combinations of cores 132, 134, 232, 234 can be used to obtain different loss shapes as desired for particular applications.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A waveguide optical amplifier comprising:
a substrate;
a cladding layer disposed on the substrate;
an amplifying core disposed within the cladding layer; and
a secondary core disposed within the cladding layer proximate the amplifying core, the secondary core being adapted to absorb at least a portion of a light signal being transmitted through the amplifying core.

2. The waveguide optical amplifier according to claim 1, wherein the amplifying core is constructed from a polymer.

3. The waveguide optical amplifier according to claim 1, wherein the amplifying core and the secondary core are constructed from the same material.

4. The waveguide optical amplifier according to claim 1, wherein the secondary core is generally parallel to the amplifying core.

5. The waveguide optical amplifier according to claim 4, wherein the amplifying core is at least as long as the secondary core.

6. The waveguide optical amplifier according to claim 1, wherein the amplifying core is doped with a rare earth element.

7. The waveguide optical amplifier according to claim 1, wherein the secondary core comprises a plurality of secondary cores.

8. A dynamic gain flattening waveguide optical amplifier comprising:
a substrate;
a cladding layer disposed on the substrate;
an amplifying core disposed within the cladding layer, the amplifying core having an output;
a secondary core disposed within the cladding layer proximate the amplifying core; and
a feedback loop including:
a tap optically connected to the output;
a gain flattening controller optically connected to the tap, the gain flattening controller including a voltage generator; and
an electrical conductor electrically connecting the voltage generator to a heater, the heater being disposed proximate to the secondary core.

9. The dynamic gain flattening waveguide optical amplifier according to claim 8, wherein the amplifying core is constructed from a polymer.

10. The dynamic gain flattening waveguide optical amplifier according to claim 8, wherein the amplifying core and the secondary core are constructed from the same material.

11. The dynamic gain flattening waveguide optical amplifier according to claim 8, wherein the secondary core is generally parallel to the amplifying core.

12. The dynamic gain flattening waveguide optical amplifier according to claim 11, wherein the amplifying core is at least as long as the secondary core.

13. The dynamic gain flattening waveguide optical amplifier according to claim 8, wherein the amplifying core is doped with a rare earth element.

14. The dynamic gain flattening waveguide optical amplifier according to claim 8, wherein the secondary core comprises a plurality of secondary cores.

15. The dynamic gain flattening waveguide optical amplifier according to claim 14, wherein the heater comprises a plurality of heaters, each of the plurality of heaters being disposed proximate to at least one of the plurality of secondary cores.

16. A method of dynamically flattening gain in a waveguide optical amplifier comprising:
providing a dynamic gain flattening waveguide optical amplifier including:
a substrate;
a cladding layer disposed on the substrate;
an amplifying core disposed within the cladding layer, the amplifying core having an output;
a secondary core disposed within the cladding layer proximate the amplifying core; and
a feedback loop including:
a tap optically connected to the output;
a gain flattening controller optically connected to the tap, the gain flattening controller including a voltage generator; and
an electrical conductor electrically connecting the voltage generator to a heater, the heater being disposed proximate to the secondary core;
transmitting an optical signal through the amplifying core, the amplifying core amplifying the optical signal and the secondary core attenuating the amplification of the optical signal over a selected bandwidth;
tapping a portion of the amplified optical signal, generating a tapped signal; transmitting the tapped signal to a gain flattening controller;
generating a voltage in the amplifier controller based on the value of the tapped signal; and
transmitting the voltage to the heater, wherein the voltage changes the temperature of the heater, wherein the change in temperature changes the refractive index of the secondary core, and wherein the change in the refractive index changes the gain flattening of the amplified optical signal.

17. The method according to claim 16, wherein the attenuating the amplification of the optical signal comprises attenuating predetermined wavelengths of the optical signal.
